(19) United States
(12) Patent Application Publication
(10) Pub. No.: US 2014/0279370 A1
(43) Pub. Date: Sep. 18, 2014

(54) METHODS, SYSTEMS, AND COMPUTER-READABLE MEDIA FOR PRODUCING A FIDUCIARY SCORE TO PROVIDE AN INVESTMENT OUTLOOK MODEL

(71) Applicant: Financial Tracking Technologies, LLC, Riverside, CT (US)

(72) Inventor: Walter Anthony Turner, Riverside, CT (US)

(73) Assignee: FINANCIAL TRACKING TECHNOLOGIES, LLC, Riverside, CT (US)

(21) Appl. No.: 14/215,724

(22) Filed: Mar. 17, 2014

Related U.S. Application Data
(60) Provisional application No. 61/800,512, filed on Mar. 15, 2013.

(51) Int. Cl. G06Q 40/04

(52) U.S. Cl. CPC G06Q 40/04
USPC 705/37

(57) ABSTRACT

According to one or more disclosed embodiments, a plurality of data inputs is received from a plurality of information sources regarding one or more investment portfolios, and the received plurality of data inputs is processed using a data model. The data derived from the processing of the received plurality of data inputs is then outputted. Also, the outputted data is checked against one or more predetermined guidelines. The data model can thus be continuously optimized in response to the checking of the outputted data against the one or more predetermined guidelines.

### RELATED APPLICATIONS

This application claims the benefit of and priority to U.S. Provisional Patent Application No. 61/800,512, filed Mar. 15, 2013, the contents of which are incorporated herein by reference.

### TECHNICAL FIELD

The present disclosure relates generally to financial services, and, more particularly, to constructing data models using real-time data processing.

### BACKGROUND

Investment outlook models typically attempt to forecast how returns and prices on investments in different assets (e.g., equities, bonds, etc.) vary over time. The investment models typically rely on financial data collected from myriad sources in order to make predictions. However, most current investment outlook models are not updated often enough and do not consider interrelated dynamics and world interconnections to provide for the earliest possible warning of probable investment catastrophe or, on the other hand, investment opportunity. Further, current models often do not meet the requirements of fiduciary law in establishing risk calculations and are not rapidly adaptive to sudden changes in volatility.

Due to the sheer magnitude of available information on which to base an effective investment model, efficiently and continuously monitoring the available information in real-time requires detecting trends in the information. Monitoring only when the information falls outside of a predetermined boundary may not adequately take into consideration the dynamic changes in the information as the factors evolve, nor is the statistical behavior of the evolution of the underlying factors taken into account. A moving band, for example, operates in this manner, thereby allowing for much higher speed at which data and information can be monitored. However, this dynamic operation cannot be performed manually, while still allowing the investor to make a change in a timely manner or to monetize a rapidly emerging investment opportunity.

### SUMMARY

As described in detail throughout the present disclosure, aspects of the embodiments disclosed herein provide continuous or near real-time scanning of the globe to find, gather, organize and process data and information, through models, to produce a fiduciary score for providing an investment outlook model or multiple models for investment asset classes, asset subclasses, issuer units, sectors, derivatives, geographies, groupings or issuers. The fiduciary score will include an outlook for user-defined time periods with probabilities of score certainty and score boundaries for user-defined time periods. Further, a rules engine is provided for implementing a variety of features, including, for example: providing alerts for score changes outside of user-defined guidelines, a decision support feature, a suggestive investment menu, a mechanism for stress testing, making portfolio changes by routing the trade for execution, making changes to trade instructions, and querying the score database. Moreover, the models are continuously re-estimated/optimized/updated using mathematical formulae, in order to help monitor the changes in data and information, the magnitude of the changes, and the changes in velocity of the breadth and depth of the information.

Thus, the disclosed embodiments can provide for better investment decisions (and better outcomes), cost savings for the financial intermediary using the system, as the intermediary likely cannot afford to build it on its own, time saving mechanisms, automated portfolio analysis, and automated identification of global investment opportunities in real time, among other benefits. Also, the disclosed system can check for initial and ongoing suitability of investments for the investor by detecting advanced short-term warnings and forecasts. Accordingly, this allows for a fiduciary score to be produced for each holding in a portfolio anywhere in the world.

Further objects and advantages of the disclosed embodiments will become apparent from a consideration of the drawings and ensuing description.

### BRIEF DESCRIPTION OF DRAWINGS

The foregoing and other objects, features, aspects and advantages of the embodiments disclosed herein will become more apparent from the following detailed description when taken in conjunction with the following accompanying drawings.

FIG. 1 shows a schematic representation including various components of an exemplary system for continuous data processing.

FIGS. 2A and 2B show a simplified flowchart of an exemplary process for continuous data processing.

FIGS. 3 and 4 show simplified flowcharts of exemplary processes for receiving, monitoring, and processing input data according to mathematical formulae.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE DRAWINGS

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Moreover, the terms “data” and “information” may be used interchangeably throughout the present disclosure.

It is understood that a number of the below methods are executed by at least one controller. The term “controller” refers to a hardware device that includes a memory and a processor. The memory is configured to store program instructions and the processor is specifically configured to execute said program instructions to perform one or more processes which are described further below.

Furthermore, the controller of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

An exemplary system for continuous data processing is illustrated in FIG. 1, and a corresponding exemplary method for continuous data processing is illustrated in FIGS. 2A and 2B. As shown in FIG. 1, the system 10 accepts multiple information inputs, including manual and/or continuous data inputs 14 and portfolio data 22. The manual and/or continuous data inputs 14 may stem from myriad sources, including, for example, vendors, governments, portfolio accounting, custodians, execution venues, or any combination of the above. It should be understood that the manual and/or continuous data inputs 14 may stem from any suitable source, and the above-referenced sources are provided for demonstration purposes only. Moreover, the manual and/or continuous data inputs 14 may consist of myriad data types. For example, these data types, or inputs, may consist of information related to boundaries for guidelines, economic data, demographic data, news, global systemic risk, issuer data, country data, regional data, capital markets data, central bank data, economic utility data, behavioral finance data, political data, indices, regulatory data, weather, innovation data, supply and demand indicators, factor markets indicators, goods markets indicators, household data, government data, capital flows, economic systems, money data, trade data, sentiment indicators, relationship data, ratings, commodity data, leverage data, exposures, linkages, investor profile data, investor group demographics, and the like.

The data inputs 14 may be collected and processed by the system 10 via the interface process 16 using a transmission of data, whereby the transmission of data may be continuous (e.g., in real-time) or performed manually. The interface 16 provides for receiving and processing data and consists of code (e.g., processing instructions 24) and data destination fields. Also, the system 10 may include one or more CPUs 18 for processing the inputted data. To this point, the CPUs 18 may process the data through data models, including single or multi-factor models, as described below. The data models may be predictive models that emulate variables along with interrelated dynamics and may utilize either non-linear or linear mathematical techniques, as explained below.

Multiple-factor models (MFMs) are formal statements about the relationships among data and information. The basic premise of MFMs is that similar data may display similar returns. Data can be similar in terms of quantifiable attributes, such as market information (e.g., price changes and volume), fundamental company data (e.g., industry and capitalization), or exposure to other factors (e.g., interest rate changes and liquidity). MFMs also identify common factors, which are categories defined by common characteristics, and determine the sensitivity to these factors.

MFMs can be divided into three types: macroeconomic factor models, fundamental factor models, and statistical factor models. Macroeconomic factor models use observable economic variables, such as changes in inflation and interest rates, as measures of the pervasive shocks to security returns. Fundamental factor models use the returns to portfolios associated with observed security attributes, such as dividend yield, book-to-market ratio, and industry membership. Statistical factor models derive their factors from factor analysis of the covariance matrix of security returns.

For instance, an equity models is an example of a fundamental factor model, which outperforms the macroeconomic and statistical models in terms of explanatory power. On the other hand, a fixed-income model is a combination of the fundamental and macroeconomic factor models. Returns of high-quality debt are largely explained by macroeconomic factors, such as changes in the default-free or other low-risk yields (e.g., in terms of government bond returns or movements of the swap curve). Returns of other forms of debt are accounted for by fundamental factors based on industry and credit quality, in addition to macroeconomic factors.

MFMs are derived from patterns observed over time. The exposures to these factors are specified or calculated. Then, a cross-sectional regression is performed to determine the returns to each factor over the relevant time period. A history of the factor is taken to create the common factor risk model with its variance-covariance matrix. The resulting models forecast a fiduciary score.

Formulae for the models may include a build on single-factor models by including and describing the interrelationships among factors. As explained above, the single-factor models may include a single factor, whereas the multiple-factor mode may include many factors. The formulae may be expanded as follows:

Single-factor model: ri=xif+ui, where ri=total excess return over the risk-free rate of security i, xi=sensitivity of security i to the factor, f=rate of return on the factor, and ui=non-factor or specific return of security i.

Multiple-factor model: rj=x1f1+x2f2+x3f3 . . .xkfk+uj.

Accordingly, the above models can identify correlations between capitals markets data, for example, and economic data, demographic data, news, global systemic risk, issuer data, country data, regional data, capital markets data, central bank data, economic utility data, behavioral finance data, political data, indices, regulatory data, weather, innovation data, supply and demand indicators, factor markets indicators, goods markets indicators, household data, government data, capital flows, economic systems, money data, trade data, sentiment indicators, relationship data, ratings, commodity data, leverage data, exposures, linkages, investor profile data, investor group demographics, and the like, so as to predict the outlook (e.g., the fiduciary score) for the investment asset classes, asset subclasses, issuer units, sectors, derivatives, geographies, groupings, or issuers.

The correlations identified by the above models may be rationalized. That is, the models produce a fiduciary score for providing an investment outlook model(s), each defined as being tied to a category, such as a positive, neutral, or negative outlook, for various time periods. The time periods could be, for example, 10 days, six months, one year, three years, 10 years, etc. Additional models may provide a certainty of probability rating as a percentage, ranges of certainty ratings as percentages and staying within boundary probabilities as percentages over time periods, certainty of probability rating, ranges of certainty ratings and staying within boundary probabilities.

The models could be used for other purposes, as well, such as to aid participants in a retirement plan or fiduciaries serving the plan, such as a 401K, as the output could be used to score the holdings of the investment choices or the choices collectively in the plan (e.g., mutual fund), and determine if the investment selections menu (e.g., the funds) in the plan are adequate to cover the needs of the participants based on the demographics or investor profile of the participants. Choosing the proper selections in the plan would produce better outcomes for plan participants as they prepare for retirement. This information should be regularly refreshed in the system, and would also reduce plan sponsor liability.

Due to the sheer magnitude of available information on which to base an effective investment model, efficiently and continuously monitoring the available information in real-time requires detecting trends in the information. Monitoring only when the information falls outside of a predetermined boundary may not adequately take into consideration the dynamic changes in the information as the factors evolve, nor is the statistical behavior of the evolution of the underlying factors taken into account. A moving band, for example, operates in this manner, thereby allowing for much higher speed at which data and information can be monitored. Moving band formulae can consider single data points or groups of data points. Examples of moving band formulae are described in detail below.

FIGS. 3 and 4 show simplified flowcharts of exemplary processes for receiving, monitoring, and processing input data according to mathematical formulae. As shown in FIG. 3, an illustrative process 300 begins at step 305, proceeds to step 305, and so forth. At step 310, data observations are grouped into blocks of size n, for example one or two weeks (e.g., n=5 or 10). An example formula is included in step 310. At step 315, for each group of blocks, the average and the range (e.g., high to low) of each group may be calculated. Example formulas are included in step 315. At step 320, before the start of a new group period (e.g., one or two weeks), the trailing average of the averages up to that point may be computed. Also, the trailing averages of the ranges (e.g., at the end of each period) may be computed. Example formulas are included in step 320. At step 325, the current mean M may be estimated based on the trailing average computed in step 320. In addition, at step 330, the current standard deviation S may be estimated based on the trailing average range computed in step 325, and divided by the number d2, whereby d2 is a function of the group size n. The process 300 then illustratively ends at step 335.

Similarly, as shown in FIG. 4, an illustrative process 400 begins at step 405, proceeds to step 405, and so forth. At step 410, a variable is tracked, whereby the variable is represented as L. For example, L could denote the price-earnings (PE) ratio of a stock. Also, L can be tracked for a time duration (e.g., period t). At step 415, the value of the level of the variable L at the end of the period t is denoted by Lₜ. For example, if the PE ratio on day one equals 5, and then the ratio on day two changes to 5.3, L₁=5, while L₂=5.3. Then, at step 420, the percentage return of the variable L from period j-1 to j is denoted by Rⱼ, whereby the index j starts at a value of one and progresses forward (L₀ is the initial value of variable L). An example formula is included in step 420. Using this formula, and continuing the above example, if the initial value of the PE ratio equals 4.8, then R₁=(5−4.8)/4.8=0.04, and R₁=(5.3−5)/5=0.06. At step 425, the average percentage return of the tracked variable L over the first T periods is denoted by R_{T}. An example formula is included in step 425. Using this formula, and within the above example, the average percentage change in the PE ratio over the first two days (e.g., T=2) is equal to (½)*(0.04+.06)=0.05. At step 430, the standard deviation of the percentage change in the level over the first T periods is σ_{T}, as defined by the example formula is included in step 430. At step 435, the single alarm, or breakout level B, for the tracked variable L is a level at which L has a percentage return larger than that expected, given the previous statistical history of L, while allowing for some statistical fluctuations that may occur without a change in trend. The breakout level B for the period T+1 is defined by the example formula is included in step 430. The process 400 then illustratively ends at step 435.

The steps illustrated in FIGS. 3 and 4 may be implemented by the system for continuous data processing 10, as illustrated in FIG. 1. For example, exceptions to guidelines 26 can be reported to a guideline and exception processing apparatus 36 and distributed as data 30. Then, the data 30 may be stored by guideline and exception storing process 32. The guidelines may include, for example, a high/low boundary, a threshold if crossed, a characteristic that must be met for the scores, and ranges of certainty.

Additional processes linked to the CPUs 18 may assist in various facets of the data processing. The processes may be implemented as computer instructions executed by a computer (e.g., CPUs 18), for example. Illustratively, the additional processes may include, for example, a database querying process 34, a portfolio “stress test” process 38, a scenario testing process 40, a trading instructions transmission process 42, an investment menu suggestion process 44, a data processing model 46, and a derived data production process 48 that derives data from the data processing model 46. The above processes are further illustrated in the flowchart shown in FIGS. 2A and 2B.

As noted above, data may be inputted into the system 10 either manually or automatically, or both, from any suitable information source. These sources include, but are not limited to, vendors, governments, portfolio accounting systems, custodians, execution venues, or any combination thereof. Moreover, the manual and/or continuous data inputs (e.g., input data 14) may consist of myriad data types. For example, these data types, or inputs, may consist of information related to boundaries for guidelines, economic data, demographic data, news, global systemic risk, issuer data, country data, regional data, capital markets data, central bank data, economic utility data, behavioral finance data, political data, indices, regulatory data, weather, innovation data, supply and demand indicators, factor markets indicators, goods markets indicators, household data, government data, capital flows, economic systems, money data, trade data, sentiment indicators, relationship data, ratings, commodity data, leverage data, exposures, linkages, investor profile data, investor group demographics, and the like.

Ongoing monitoring may also be performed by the system 10 to determine if data needs to be added or deleted when the systematic data gathering methods collect new data from the myriad sources (described above) or determine whether changes need to be made. The data is used to determine correlations between primary capital markets data and other data. Collectively, this information is cleansed, normalized, prepared for data integrity and then merged and placed into a master database in preparation for processing into the models. The data is also sorted for subsequent querying in the database.

A computer network is utilized for these processes consisting at least of a database, CPUs, hard drives, and a display apparatus. The computer network allows the system 10 to rapidly ingest new data from myriad data sources. Next, given the breadth and depth of the data to be monitored or analyzed, a moving band can be used to identify outliers and volatility in data points. After any data outliers are identified and an appropriate corrective action has been taken, if any, the data may then be processed through the predictive models, and a fiduciary score is produced for each holding in a portfolio, for investment asset classes, asset subclasses, issuer units, sectors, derivatives, geographies, groupings, or issuers. The process to run the models may start over again with new data added, changed, or deleted (e.g., news or news indices), so as to continue to rationally refine or re-estimate the models. The results and/or deviations from past predictive models can also be input into the models as feedback.

The models can also process data for investments so as to provide a fiduciary score. To this end, a database can be utilized and queried for a variety purposes, such as: 1) a suggestive investment menu for the investor, investor group, or financial intermediary, 2) a general query for investment asset classes, asset subclasses, issuer units, sectors, derivatives, geographies, groupings, or issuers by category, fiduciary score, probabilities score certainty, etc., 3) automated trading to realign the portfolio when circumstances change, and 4) to “stress test” portfolios or to enable a “what if a trade is made”-type scenario testing.

The results of the models' processing are checked against user-defined guidelines to determine whether a breach of a rule or guidelines has occurred. Up to this point in the workflow process, a process for automatically analyzing the raw data is input into the system for outliers and the output of the models in comparison with the guidelines is automatically analyzed. Vast amounts of data can be continuously processed and analyzed all on exceptions-based alerts.

At this point, the user can transmit trade instructions to an execution venue to facilitate and initiate a trade. Moreover, the trade instructions may be generated based on the results of the automated analysis processes, if the user desires. The user can also instruct the system to automatically initiate trades based on the results of the analysis processes so as to bring the portfolio back to within guidelines, e.g., when an event outside of the guidelines is recognized.

The results of the models are stored and included in several aspects of guidelines calculations, such as the moving bands calculations, the number of exceptions, trends in changes in fiduciary scores, and the like. Also, the results of the models may output a particular fiduciary score. The fiduciary score is customizable and may be outputted in a wide variety of ways, including, for example, a fiduciary score for a particular time period, a fiduciary score with a score certainty probability, a fiduciary score with a score certainly probabilities for a particular time period, a fiduciary score with a range of score certainty probabilities, a fiduciary score with a range of score certainty probabilities for a particular time period, a fiduciary score with a score certainty probability that the score remains between fiduciary score boundaries for a particular time period, a fiduciary score with a range of score certainty probabilities that the score remains between fiduciary score boundaries for a particular time period, a fiduciary score with a score certainty probability that the score remains between fiduciary score boundaries, a fiduciary score with a range of score certainty probabilities that the score remains between fiduciary score boundaries, and so forth. Furthermore, the results of the models may output additional information regarding changes or trends in the inputted information, such as, for example, the magnitude of changes in data, the magnitude of changes in derived data, the changes of velocity in changes in data, and so forth.

After the results are produced, the results may be displayed by the system for continuous data processing 10. Alternatively, or additionally, the displaying may occur at various points in the process, as illustrated in FIGS. 2A and 2B, depending on user choice, for example, since the data and derived data are queriable at any time. The models may then be re-processed continuously or on-demand.

### Equivalents

While the above description contains many specificities, these should not be construed as limitations on the scope of the invention, but rather as an exemplification of one preferred embodiment thereof. Many other variations are possible, including, for example, a system for portfolios, the system for portfolios including an interface, the system for portfolios including an interface capable of distributing results via the World Wide Web, and so forth. It is expressly contemplated that the components and/or elements described herein can be implemented as an apparatus that comprises at least one network interface that communicates with a communication network, a processor coupled to the at least one network interface, and a memory configured to store program instructions executable by the processor. Further, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, the scope of the disclosed system should be determined not by the embodiment(s) described, but by the appended claims and their legal equivalents.

1. A method of securities trading, the method comprising:
receiving a plurality of data inputs from a plurality of information sources regarding one or more investment portfolios;
processing the received plurality of data inputs using a data model;
outputting data derived from the processing of the received plurality of data inputs;
checking the outputted data against one or more predetermined guidelines; and
continuously optimizing the data model in response to the checking of the outputted data against the one or more predetermined guidelines.

2. The method of claim 1, wherein the receiving of the plurality of data inputs comprises continuously receiving the plurality of data inputs from the plurality of information sources in real-time.

3. The method of claim 1, wherein the data model is a multi-factor model.

4. The method of claim 1, further comprising continuously re-estimating the data model based on results of previous data processing or a deviation from the results of previous data processing.

5. The method of claim 1, further comprising:
generating an exception to the one or more predetermined guidelines; and
determining whether the outputted data satisfies the exception.

6. The method of claim 1, wherein the outputted data is a fiduciary score for providing an investment outlook model.

7. The method of claim 1, wherein the outputted data is a fiduciary score and one or more of: a time period, a score certainty probability, a range of score certainty probabilities, a score certainty probability that the fiduciary score will remain between fiduciary score boundaries, a range of score certainty probabilities that the fiduciary score will remain between fiduciary score boundaries, a score certainty probability that the fiduciary score will remain between fiduciary score boundaries for a time period, and a range of score certainty probabilities that the fiduciary score will remain between fiduciary score boundaries for a time period.

8. The method of claim 1, further comprising generating an alert when the outputted data falls outside the one or more predetermined guidelines.

9. The method of claim 1, further comprising:
storing the outputted data in a database; and
querying the database when continuously optimizing the data model.

10. The method of claim 1, further comprising utilizing mathematical formulae to monitor one or more of: changes in the received plurality of data inputs, changes in the outputted data, changes in velocity of changes in the received plurality of data inputs, and changes in velocity of changes in the outputted data.

11. A non-transitory computer readable medium containing program instructions that cause a computer to execute a process, the process comprising:
receiving a plurality of data inputs from a plurality of information sources regarding one or more investment portfolios;
processing the received plurality of data inputs using a data model;
outputting data derived from the processing of the received plurality of data inputs;
checking the outputted data against one or more predetermined guidelines; and
continuously optimizing the data model in response to the checking of the outputted data against the one or more predetermined guidelines.

12. The computer readable medium of claim 11, wherein the receiving of the plurality of data inputs comprises continuously receiving the plurality of data inputs from the plurality of information sources in real-time.

13. The computer readable medium of claim 11, wherein the data model is a multi-factor model.

14. The computer readable medium of claim 11, the process further comprising continuously re-estimating the data model based on results of previous data processing or a deviation from the results of previous data processing.

15. The computer readable medium of claim 11, the process further comprising:
generating an exception to the one or more predetermined guidelines; and
determining whether the outputted data satisfies the exception.

16. The computer readable medium of claim 11, wherein the outputted data is a fiduciary score for providing an investment outlook model.

17. The computer readable medium of claim 11, wherein the outputted data is a fiduciary score and one or more of: a time period, a score certainty probability, a range of score certainty probabilities, a score certainty probability that the fiduciary score will remain between fiduciary score boundaries, a range of score certainty probabilities that the fiduciary score will remain between fiduciary score boundaries, a score certainty probability that the fiduciary score will remain between fiduciary score boundaries for a time period, and a range of score certainty probabilities that the fiduciary score will remain between fiduciary score boundaries for a time period.

18. The computer readable medium of claim 11, the process further comprising generating an alert when the outputted data falls outside the one or more predetermined guidelines.

19. The computer readable medium of claim 11, the process further comprising:
storing the outputted data in a database; and
querying the database when continuously optimizing the data model.

20. The computer readable medium of claim 11, the process further comprising utilizing mathematical formulae to monitor one or more of: changes in the received plurality of data inputs, changes in the outputted data, changes in velocity of changes in the received plurality of data inputs, and changes in velocity of changes in the outputted data.
